(19) United States
(12) Patent Application Publication
(10) Pub. No.: US 2013/0188544 A1
(43) Pub. Date: Jul. 25, 2013

(54) Low-Power, Low-Latency, End-To-End Communication Messaging Over Multi-Hop, Heterogenous Communication Networks

(71) Applicants: Ankit Tiwari, Sturbridge, MA (US); Luiz Fernando Huet de Bacellar, Glastonbury, CT (US)

(72) Inventors: Ankit Tiwari, Sturbridge, MA (US); Luiz Fernando Huet de Bacellar, Glastonbury, CT (US)

(73) Assignee: UTC Fire & Security Corporation, Farmington, CT (US)

(21) Appl. No.: 13/878,088

(22) PCT Filed: Oct. 7, 2010
(86) PCT No.: PCT/US10/51774

§ 371 Date: Apr. 5, 2013

(51) Int. Cl. H04W 52/02

(52) U.S. Cl. CPC H04W 52/02
USPC 370/311; 370/338

(57) ABSTRACT

A system is provided and includes a server, a wireless access point disposed in signal communication with the server, an end device and a wireless end point communicative with the wireless access point and configured to interface with the end device, the server and the end device being configured to send information packets back and forth via the wireless end point, each information packet including additional information instructing the wireless end point to take subsequent action following initial action by the wireless end point relative to the information packet.

### BACKGROUND OF THE INVENTION

The subject matter disclosed herein relates to low-power, low-latency, end-to-end communication messaging over multi-hop, heterogeneous communication networks.

In heterogeneous networks that utilize low-power wireless embedded systems or in multi-hop wireless embedded systems, when two wireless devices communicate with each other via multiple intermediate devices, there is often no way for an originating device to know whether the message has reached its destination or not. All an originating device usually knows is that the message was successfully delivered to an immediate intermediate device. But in many applications, like security and fire detection systems, there is a need, at the originating device, to get an immediate response or acknowledgement for the message from the destination.

A challenge with such a system, however, would be to develop methods that would minimize the latencies between the request and the corresponding response while also minimizing the consumed power. To date, efforts at developing these methods have not focused on facilitating request-response style communication paradigms. Instead, the efforts have generally utilized beacon transmissions from a line powered wireless device for maintaining a network and for facilitating message transmission to battery powered devices. But such approaches require all network devices to implement complex time-synchronization methods and the battery powered devices need to periodically wakeup and listen for beacons. The devices hence waste significant power resources even when there are no messages to be exchanged and, moreover, the approaches resulted in increased delivery latency for exchanged packets.

### BRIEF DESCRIPTION OF THE INVENTION

According to one aspect of the invention, a system is provided and includes a server, a wireless access point disposed in signal communication with the server, an end device and a wireless end point communicative with the wireless access point and configured to interface with the end device, the server and the end device being configured to send information packets back and forth via the wireless end point, each information packet including additional information instructing the wireless end point to take subsequent action following initial action by the wireless end point relative to the information packet.

According to another aspect of the invention, a method of operating an end device, which is disposed in a system whereby the end device and a server send information packets back and forth via a wireless end point and a wireless access point, the method including preparing an information packet to be sent to the server and embedding in the information packet an instruction that the wireless end point is to take subsequent action following initial action by the wireless end point relative to the information packet.

According to yet another aspect of the invention, a method of operating a wireless end point, which is disposed in a system whereby an end device and a server send information packets back and forth via the wireless end point and a wireless access point, the method including receiving an information packet, including information packet content and additional information, reading an instruction in the additional information independent of a readability of information packet content and taking an initial action with respect to the information packet and taking a subsequent action in accordance with the instruction.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exemplary system architecture;

FIG. 2 is a flow diagram illustrating an operation of application end devices; and

FIGS. 3 and 4 are flow diagrams illustrating transmit logic and receive logic used at wireless end points.

The detailed description explains embodiments of the invention, together with advantages and features, by way of example with reference to the drawings.

### DETAILED DESCRIPTION OF THE INVENTION

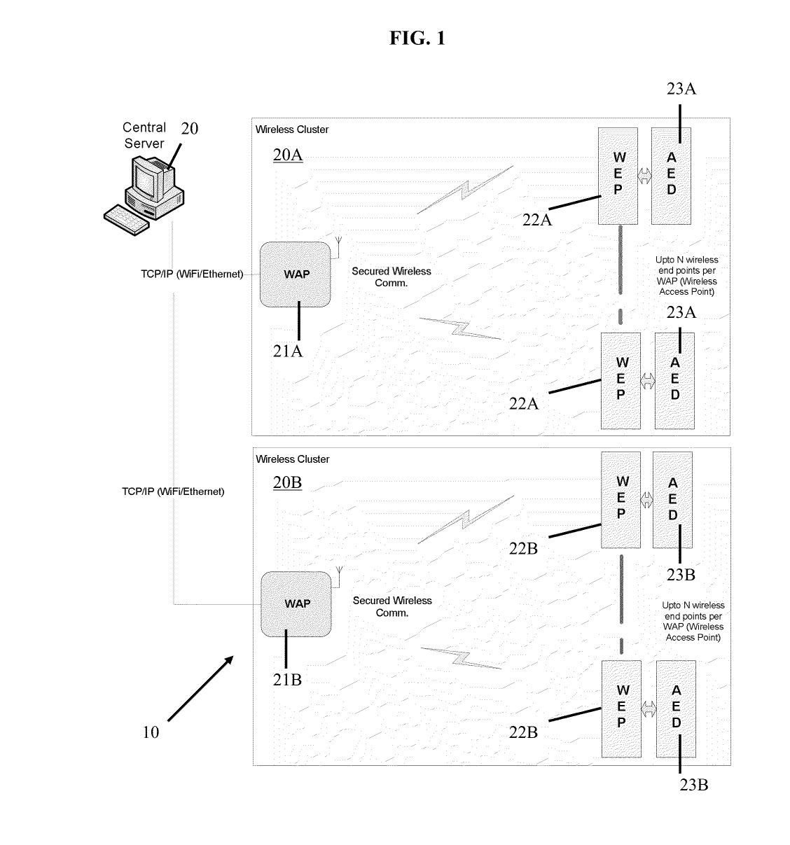

In accordance with aspects of the invention and, with reference to FIG. 1, a communication protocol is developed to facilitate a Request-Response type of communication between at least two or more application end devices utilizing a wireless link in a system 10. The system 10 is architected such that there is a central server 20, which acts as one of the application end devices, and multiple wireless clusters 20A, 20B remote from the central server 20. Each of the multiple wireless clusters 20A, 20B has a line-powered wireless access point (WAP) 21A, 21B, respectively, and one or more (i.e., multiple, N) battery-powered wireless end points (WEPs) 22A, 22B, respectively, such as transceivers and/or transponders.

The wireless access points 21A, 21B are disposed in signal communication with the central server 20 by way of TCP/IP (WiFi/Ethernet) systems, for example, and with the corresponding wireless end points 22A, 22B, respectively, by way of secured wireless connections. Each wireless end point 22A, 22B interfaces with a corresponding application end device (AED) 23A, 23B, such as, for example, a lock, a security detector, a fire detector, a heat detector, a smoke detector/alarm, a carbon monoxide detector and/or another similar device. The wireless network, in the exemplary system 10 of FIG. 1, thus facilitates communication between the central server 20 and at least one of the distributed application end devices 23A, 23B.

An example of the Request-Response type of communication would be a message sent by application end device 23A, which is battery-powered, for which an immediate response or acknowledgement from the central server 20 is expected or vice-versa. Under such communication paradigms, it is important that the battery-powered wireless end point 22A stays awake to be in a condition for receiving the response from the central server 20 after forwarding the message from the battery-powered application end device 23A. Also for conserving battery power, it is important that the battery-powered wireless end point 22A stays awake only if a response is needed and then sleeps once the response is received or a time out occurs after a predefined period of time.

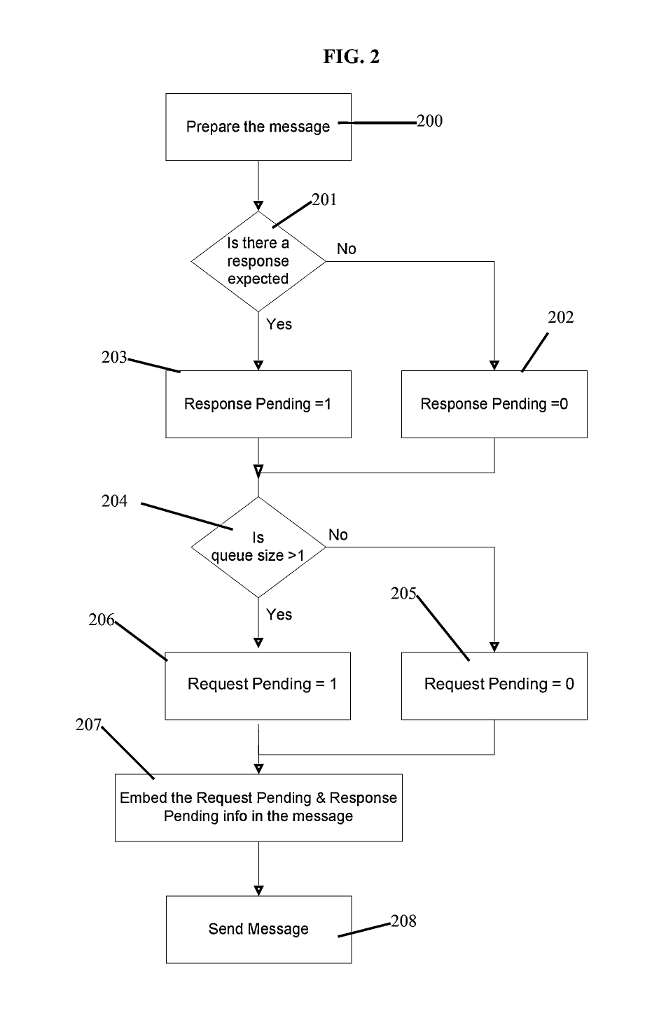

A protocol of the invention embeds the request pending and response pending information in every message and, with reference to FIG. 2, it is to be understood that logic is used by the application end devices 23A, 23B for embedding the messages with proper information. This way, an intermediate battery-powered wireless end point 22A, 22B, which forwards the message to the central server 20, would not be required to understand the application level messages but would still know whether a response or another request after this message is or should be pending. This allows a transmitting intermediate device to know whether it needs to stay awake for receiving the response or not. This also allows a receiving intermediate device to similarly know whether it needs to stay awake to receive another request or not.

In accordance with embodiments of the invention, as shown in FIG. 2, the application end device 23A first prepares the message (200) and, in so doing, determines if a response is or should be expected 201. If not, a value for “response pending” is set to zero (202). If a response is expected, the value for “response pending” is set to one (203). At this point, it is determined whether queue size is greater than one (204). That is, it is determined whether there are any more messages that will be sent to the wireless end point 22A, 22B immediately following the current message. If not, a value for “request pending” is set to zero (205) and, if so, the value for “request pending” is set to one (206). The application end device 23A then embeds the “request pending” and “response pending” information into the message (207) by indicating the zero or one values for the “request pending” and the “response pending.” At this point, the application end device 23A sends the message (208).

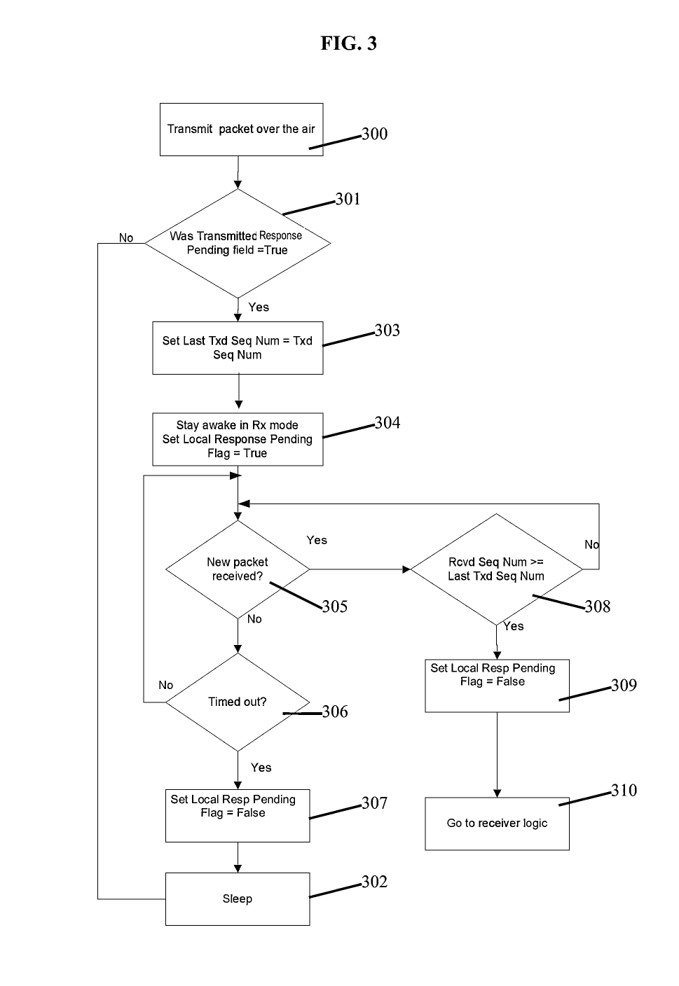

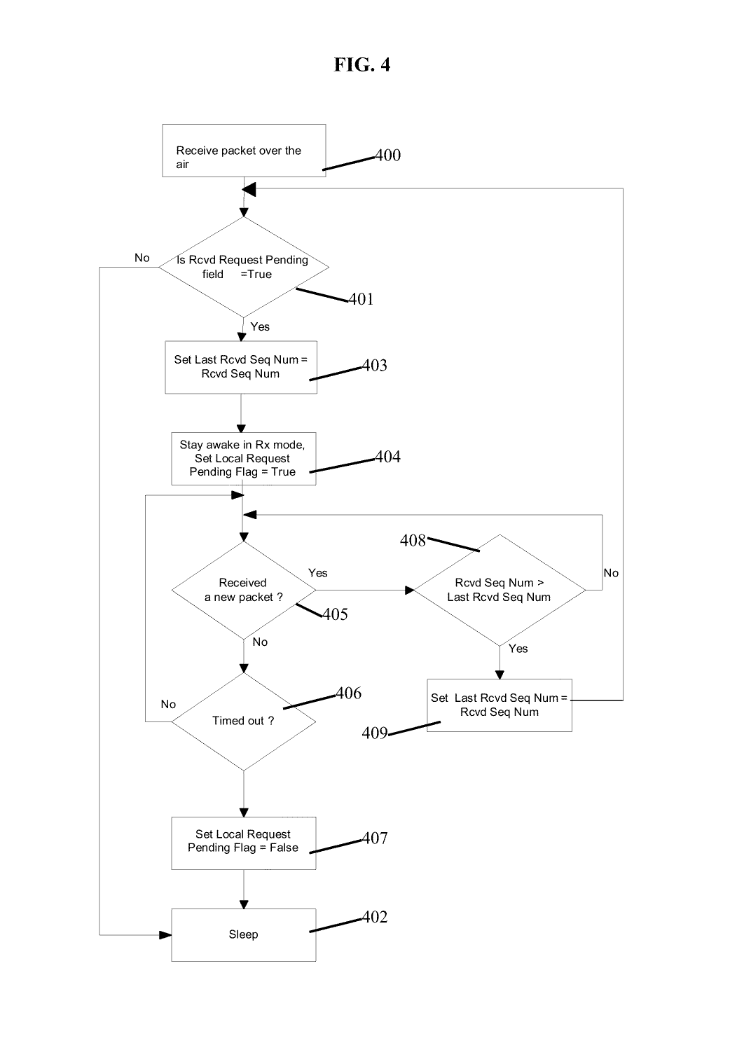

The battery-powered wireless end points 22A, 22B use a specific logic for processing the messages sent by the application end devices 23A, 23B, as described above, with the embedded information and for determining whether to stay awake or not. With reference to FIG. 3, the logic used at each of the wireless end points 22A, 22B after transmitting the messages over-the-air is outlined and, with reference to FIG. 4, the logic used at each of the wireless end points 22A, 22B after receiving the messages over-the-air is outlined.

In accordance with an embodiment and, as shown in FIG. 3, the wireless end point 22A sleeps most of the time to conserve battery power and wakes up only if there is an event at the corresponding application end device 23A that needs to be transmitted to the central server 20. After transmitting the event message (300), the wireless end point 22A determines if a response is pending (301). If a response is not pending, the wireless end point 22A goes to sleep (302). If a response is pending, the wireless end point 22A sets a value for the last transmitted sequence number to be equal to a transmitted sequence number (303) and stays awake in response mode while setting a local response pending flag to have a “true” value (304).

At this point, the wireless end point 22A determines if a new packet has been received (305). If no new packet has been received, a time out occurs after a predefined period of time (306), the wireless end point 22A sets the local response pending flag to have a “false” value (307) and goes to sleep (302), as above. If a new packet has been received, the wireless end point 22A determines whether the sequence number of the received packet is greater than or equal to the sequence number of the last transmitted packet (308) and, if the sequence number of the received packet is not greater than or equal to the sequence number of the last transmitted packet, control reverts to the determination of whether a new packet has been received (305). If the sequence number of the received packet is greater than or equal to the sequence number of the last transmitted packet, the wireless end point 22A sets the local response pending flag to have a “false” value (309) and receiver logic (see FIG. 4) can be executed (310).

That is, the wireless end point 22A goes to sleep after receiving a response and, apart from the event transmissions, wakes up periodically to transmit a heartbeat message to the wireless access point 21A. If there is a message waiting for the battery-powered application end device 23A at the wireless access point 21A, a stay-awake signal is sent in response to the heartbeat message. The wireless end point 22A, on receiving the stay-awake message in response to its heartbeat, would stay awake for receiving the pending message from the wireless access point 21A. After receiving the message, the wireless end point applies the logic outlined in FIG. 4 to determine whether to stay awake or go back to sleep.

As shown in FIG. 4, this logic begins with a reception of a packet (400) and a determination of whether a received request pending field value is “true” or not (401). If the received request pending field value is not “true,” the wireless end point 22A goes to sleep (402) and, if the received request pending field value is “true,” the wireless end point 22A sets a last received sequence number of a last received packet to be equal to the sequence number of the last received packet (403) and stays awake in receiving mode while setting the local request pending flag value to be “true” (404).

At this point, the wireless end point 22A determines if a new packet has been received (405). If no new packet has been received, a time out occurs after a predefined period of time (406), the wireless end point 22A sets the local request pending flag to have a “false” value (407) and goes to sleep (402), as above. If a new packet has been received, the wireless end point 22A determines whether the sequence number of the received packet is greater than the sequence number of the last received packet (408) and, if the sequence number of the received packet is not greater than the sequence number of the last received packet, control reverts to the determination of whether a new packet has been received (405). If the sequence number of the received packet is greater than or equal to the sequence number of the last received packet, the wireless end point 22A sets the last received sequence number of the last received packet to be equal to the sequence number of the last received packet (409) and control reverts to the determination of whether a received request pending field value is “true” or not (401).

In an alternative embodiment, the wireless end points 22A, 22B can implement logic to stay awake in receive mode for a predefined time after either transmitting or receiving an application message. Although the wireless end points 22A, 22B expend more battery when using this logic, it minimizes the latency between a request transmission and a response reception. This approach allows the wireless end points 22A, 22B to interface with the application end devices 23A, 23B, respectively that do not implement the logic outlined in FIG. 2 or have no way of knowing if a response or request will be coming back following the current message.

In accordance with aspects of the invention, battery powered devices are kept awake only when needed and only for as long as needed, and features such as emergency lock-down with low latencies, while consuming minimal battery power are enabled. The description provided above leverages periodic heartbeat messages, transmitted by the battery powered devices, to initiate transmission of messages to the battery-powered devices and minimizes the latencies between consecutive transmissions and receptions between the transmission of a request and the reception of the corresponding response and between the reception of a response and the reception of a subsequent request. Beacon transmissions, frequent wakeups to listen for message requests, network time-synchronization algorithms, all of which cost significant battery power on a continuous basis are not necessary.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system, comprising:
a server;
a wireless access point disposed in signal communication with the server;
an end device; and
a wireless end point communicative with the wireless access point and configured to interface with the end device,
the server and the end device being configured to send information packets back and forth via the wireless end point, each information packet including:
additional information instructing the wireless end point to take subsequent action following initial action by the wireless end point relative to the information packet.

2. The system according to claim 1, wherein the wireless access point is disposed in signal communication with the server via a TCP/IP based network.

3. The system according to claim 1, wherein the wireless end point communicates with the corresponding wireless access point via a secured wireless connection.

4. The system according to claim 1, wherein the end device comprises a lock, a security detector, a fire detector, a heat detector, a smoke detector/alarm and/or a carbon monoxide detector.

5. The system according to claim 1, wherein the end device is plural in number and the plural end devices, the wireless end point and the wireless access point are disposed within a cluster remote from the server.

6. The system according to claim 5, wherein the cluster is plural in number.

7. The system according to claim 1, wherein the initial action comprises one of transmitting the information packet and receiving the information packet.

8. The system according to claim 7, wherein the subsequent action comprises the wireless end point staying awake and going to sleep.

9. The system according to claim 1, wherein the additional information is readable by the wireless end point independent of a readability of information packet content by the wireless end point.

10. The system according to claim 1, wherein the additional information comprises a response pending indication to instruct the wireless end point to stay awake pending a response.

11. The system according to claim 1, wherein the additional information comprises a request pending indication to instruct the wireless end point to stay awake pending a request.

12. A method of operating an end device, which is disposed in a system whereby the end device and a server send information packets back and forth via a wireless end point and a wireless access point, the method comprising:
preparing an information packet to be sent to the server; and
embedding in the information packet an instruction that the wireless end point is to take subsequent action following initial action by the wireless end point relative to the information packet.

13. The method according to claim 12, wherein the initial action comprises one of transmitting the information packet and receiving the information packet.

14. The system according to claim 12, wherein the subsequent action comprises the wireless end point staying awake and going to sleep.

15. The method according to claim 12, wherein the instruction is readable by the wireless end point independent of a readability of information packet content by the wireless end point.

16. The method according to claim 12, wherein the embedding comprises:
determining whether a response to the information packet is expected; and
in an event that no response is expected, embedding within the information packet an indication that no response is pending, or,
in an event that the response is expected, embedding within the information packet an indication that the response is pending.

17. The method according to claim 12, wherein the embedding comprises:
determining whether a queue size is greater than 1; and
in an event that the queue size is not greater than 1, embedding within the information packet an indication that no request is pending, or,
in an event that the queue size is greater than 1, embedding within the information packet an indication that a request is pending.

18. A method of operating a wireless end point, which is disposed in a system whereby an end device and a server send information packets back and forth via the wireless end point and a wireless access point, the method comprising:
receiving an information packet, including information packet content and additional information;
reading an instruction in the additional information independent of a readability of information packet content; and
taking an initial action with respect to the information packet and taking a subsequent action in accordance with the instruction.

19. The method according to claim 18, wherein the initial action comprises one of transmitting the information packet and receiving the information packet.

20. The system according to claim 18, wherein the subsequent action comprises the wireless end point staying awake and going to sleep.
